(19) United States
(12) Patent Application Publication
(10) Pub. No.: US 2025/0336562 A1
(43) Pub. Date: Oct. 30, 2025

(54) ION SOURCE WITH BACKWARD ELECTRON BEAM IONIZATION

(71) Applicant: Nusano, Inc., Valencia, CA (US)

(72) Inventors: Glenn B. Rosenthal, Los Angeles, CA (US); Christopher A. Balley, Lindon, UT (US); Richard W. Sisson, Hollday, UT (US); Charles Cumberland McGuire, Salt Lake City, UT (US); Melissa M. Daniels, Eagle Mountain, UT (US)

(21) Appl. No.: 19/191,116

(22) Filed: Apr. 28, 2025

Related U.S. Application Data
(60) Provisional application No. 63/640,156, filed on Apr. 29, 2024.

(51) Int. Cl. G21K 1/087; H01J 27/26

(52) U.S. Cl. CPC G21K 1/087; H01J 27/26

(57) ABSTRACT

Various embodiments include an ion source assembly. The ion source assembly may include an oven configured to receive a charge material through an upstream end, an ionization reaction volume adjacent a downstream end of the oven that may be configured to receive a neutral gas, a cathode assembly positioned to generate an electron beam directed toward the ionization reaction volume, and an anode positioned downstream of the ionization reaction volume. The ionization reaction volume may be disposed between the oven and the cathode assembly. The electron beam may flow in a direction opposite to a flow of ions generated in the ionization reaction volume.

### CROSS-REFERENCE TO RELATED APPLICATIONS

This application claims the benefit of priority to U.S. Provisional Application No. 63/640,156 titled Systems and Methods for Lu-177 Isotopic Production and Separation, filed Apr. 29, 2024, which is hereby incorporated by reference in its entirety for all purposes.

### BACKGROUND

Ion sources are devices used in various scientific and industrial applications to generate beams of charged particles. These sources play a crucial role in fields such as mass spectrometry, particle accelerators, and materials analysis. Ion sources typically operate by ionizing neutral atoms or molecules through various mechanisms, including electron impact ionization, surface ionization, or plasma discharge.

The development of ion sources has progressed significantly over the years, with advancements in design and technology leading to improved performance characteristics. Modern ion sources often incorporate features such as precise control over ion beam energy and current, enhanced ionization efficiency, and the ability to produce ions from a wide range of elements and compounds. Additionally, innovations in ion optics and beam focusing techniques have enabled the creation of more compact and efficient ion source systems for specialized applications.

### SUMMARY

Various embodiments include an ion source assembly that includes an oven configured to receive a charge material through its upstream end and deliver it toward a downstream end adjacent an ionization reaction volume. The ionization reaction volume may be positioned between the oven and a cathode assembly and configured to receive a neutral gas from the oven. The cathode assembly is arranged and energized to generate an electron beam directed toward the ionization reaction volume. An anode may be positioned adjacent to the ionization reaction volume, such that the electron beam travels in a direction opposite to the flow of ions generated within the ionization reaction volume.

### BRIEF DESCRIPTION OF THE FIGURES

The accompanying drawings, which are incorporated herein and constitute part of this specification, illustrate exemplary embodiments of the claims, and, together with the general description given and the detailed description, serve to explain the features herein.

FIG. 1A is a front side elevation view of an ion source core assembly with ceramic break and electromagnet assembly removed according to various embodiments.

FIG. 1B is a rear side elevation view of the ion source core assembly of FIG. 1A according to various embodiments.

FIG. 1C is a sectional view of the ion source core assembly of FIG. 1A at C-C according to various embodiments.

FIG. 1D is an isometric view of the ion source core assembly of FIGS. 1A-1C according to various embodiments.

FIG. 1E is an exploded view of the ion source core assembly of FIGS. 1A-1D according to various embodiments.

FIGS. 2A and 2B are isometric views of an ion source assembly according to various embodiments.

FIGS. 2C, 2D, and 2E are top, side, and bottom views of the ion source assembly of FIGS. 2A and 2B according to various embodiments.

FIG. 2F is a perspective sectional view of the ion source assembly of FIGS. 2A-2E according to various embodiments.

FIG. 2G is a side cross-sectional view of the ion source assembly of FIG. 2D at G-G according to various embodiments.

FIGS. 3A and 3B are sectional relief views of an injector assembly in conjunction with an ion source assembly with a charge rod in a pre-insertion position and a fully inserted position, respectively, according to various embodiments.

FIG. 4 is a side section view of a DC ion assembly according to various embodiments.

FIG. 5 is a side sectional view of an isotope separation system according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments provide systems and methods for generating and controlling ion beams using a novel ion source configuration for use in mass spectrometry and isotope separation. Various embodiments include an ion source assembly with a backward-flowing electron beam for ionization of vaporized source atoms, including an oven for heating charge source material to sublimation or vaporization temperatures, an ionization reaction volume adjacent to the oven, a cathode assembly configured to generate an electron beam directed toward the ionization reaction volume, and an anode positioned apart from the cathode assembly. This configuration allows for efficient ionization and extraction of ions of a source material while enabling continuous operation through a removable charge rod system.

The ion source assembly incorporates several features that enhance its performance and versatility. These include a magnetic coil surrounding critical components to confine the negatively-charged plasma, high-temperature materials in the oven for improved durability, and an emission lens for focusing the extracted ion beam. The assembly is designed with multiple platforms and suspension plates, providing electrical isolation between components while maintaining thermal management through integrated cooling systems.

Various embodiments provide improvements to ion source technology by enabling more efficient ionization, easier material replacement without disassembly, and enhanced control over ion beam characteristics. The backward-flowing electron beam configuration and removable charge rod system offer potential advantages in continuous operation and maintenance of ion source systems used in scientific and industrial applications.

Current ion source technologies often struggle with efficient ionization and continuous operation, particularly in applications requiring high-temperature materials and precise control over ion beam characteristics. Many existing systems require frequent disassembly for material replacement, leading to increased downtime and reduced operational efficiency. Additionally, conventional ion sources typically employ electron beams that flow in the same direction as the generated ions, which can limit ionization efficiency and beam control. Therefore, there is an unmet need for an ion source assembly that can provide improved ionization efficiency, enable continuous operation through easy material replacement, and offer enhanced control over ion beam characteristics while maintaining a design that is both durable and compatible with high-temperature materials.

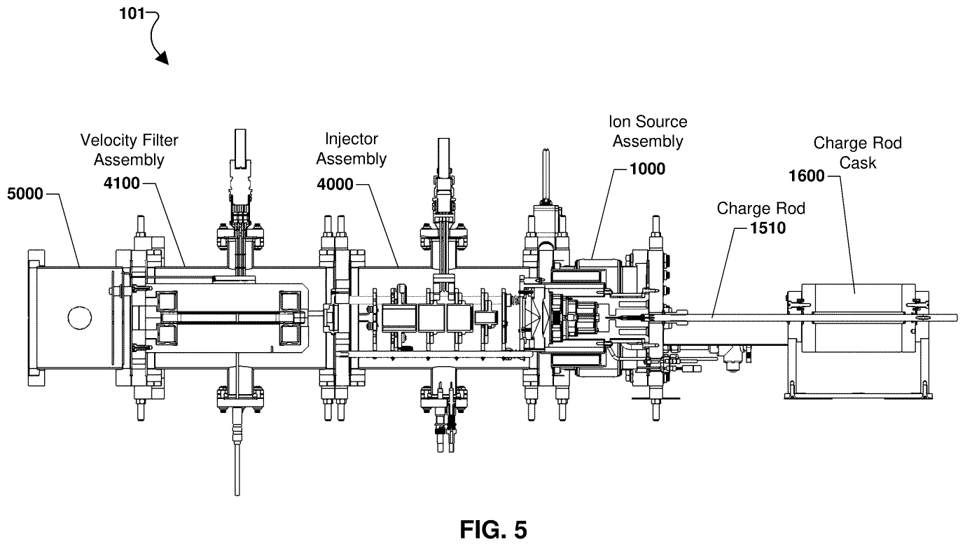

In some embodiments, an ion source assembly 1000 may be part of an isotope separation system 101. FIG. 5 illustrates a side cross-sectional view of the isotope separation system 101, illustrating how multiple components may be arranged in a linear configuration.

The isotope separation system 101 may include a velocity filter assembly 4100 positioned at an upstream end. Adjacent to the velocity filter assembly 4100, an injector assembly 4000 may be located. The ion source assembly 1000 may be positioned downstream of the injector assembly 4000. An isotope collection assembly 5000 may be positioned at the downstream end of the isotope separation system 101, completing the linear arrangement of components.

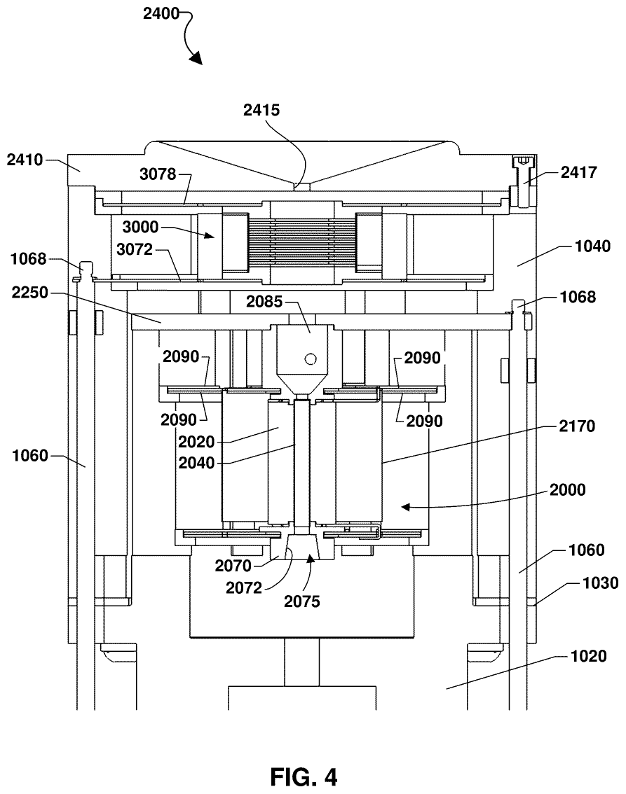

In some embodiments, the ion source assembly 1000 may include an oven (e.g., 2000 in FIG. 4) configured to receive a charge material through an upstream end. A charge rod 1510 may extend through the assembly and connect to a charge rod cask 1600 at the downstream end. The charge rod 1510 may be configured to introduce the charge material into the oven of the ion source assembly 1000.

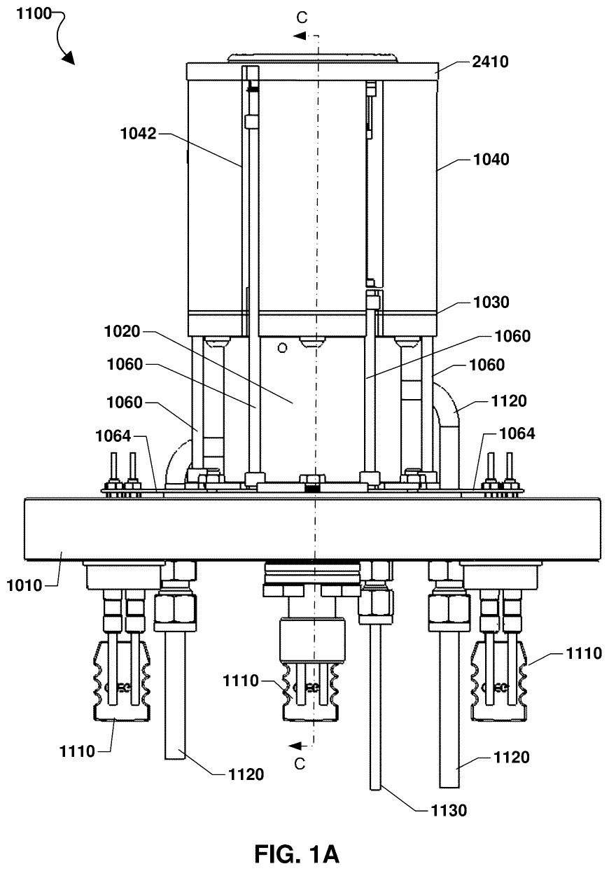

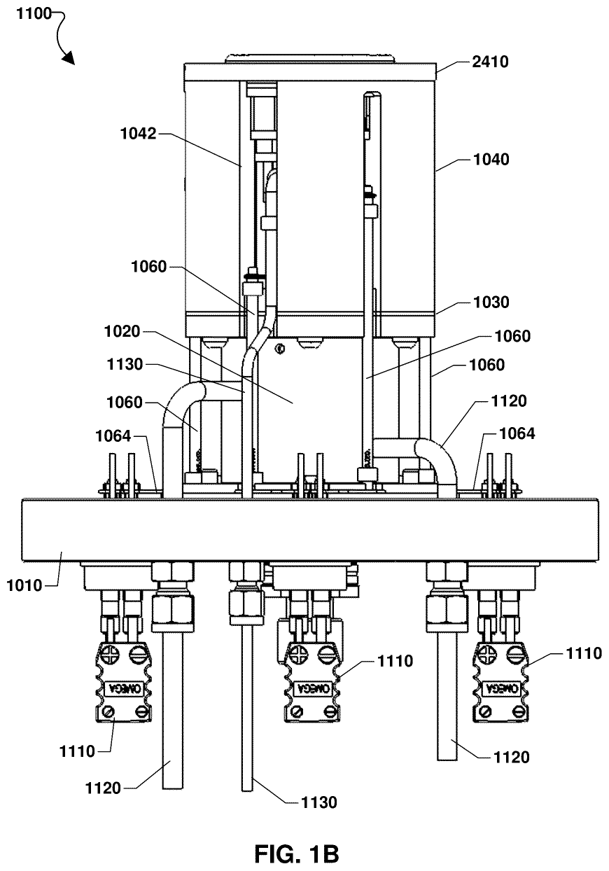

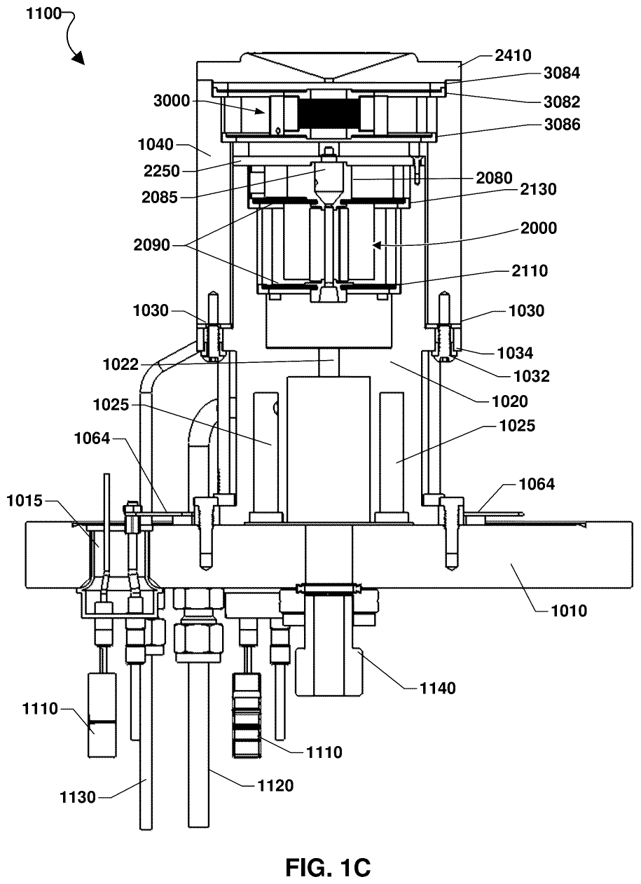

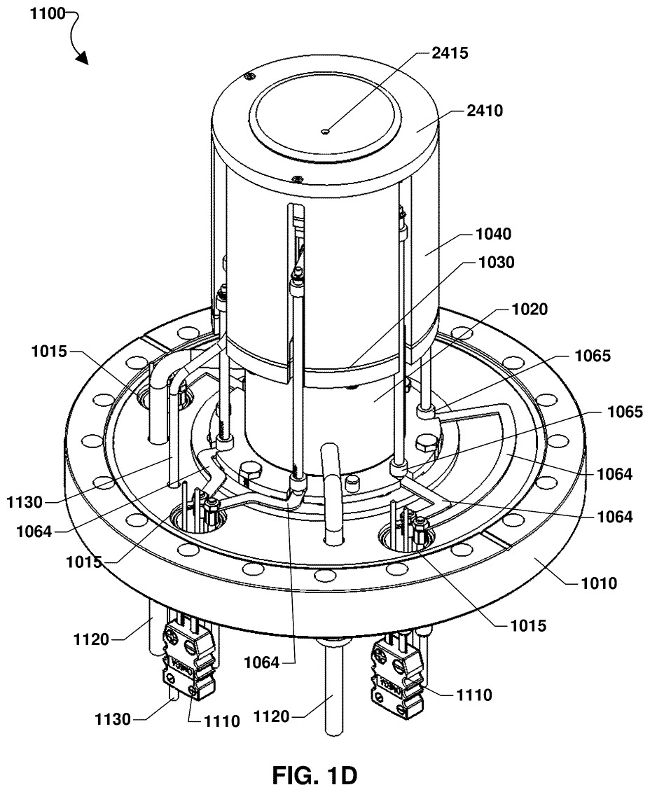

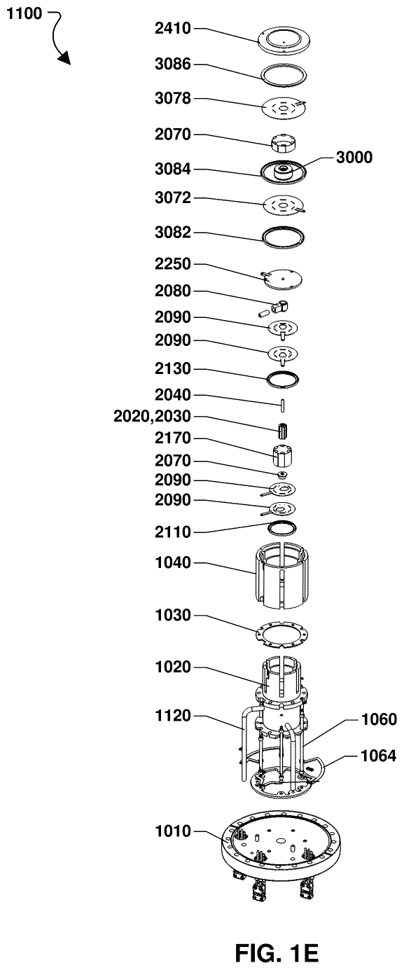

The ion source assembly 1000 may further include an ionization reaction volume (e.g., 2085 in FIG. 1C) adjacent to a downstream end of the oven that is opposite the upstream end. The ionization reaction volume may be configured to receive a neutral gas, such as a vapor of a sublimated or evaporated source material or an inert calibration gas (e.g., Ar or Xe). The ionization reaction volume is positioned between the oven and a cathode assembly (e.g., 3000 in FIG. 1C) so that electrons emitted from the cathode assembly impact and ionize vapor exiting the oven.

The cathode assembly may be positioned, configured, and energized to generate an electron beam directed toward the ionization reaction volume. An anode may be positioned adjacent to the ionization reaction volume. Electrical potentials applied to the cathode assembly and the anode cause the electron beam to flow into the ionization reaction volume and ions generated in the ionization reaction volume to flow in the opposite direction toward the cathode assembly.

The components of the ion source assembly 1000 may be arranged to allow for the generation, focusing, and filtering of ions. The various assemblies may work together to process and direct the ion beam through the system. In some embodiments, the sectional view of FIG. 5 may reveal how these components are connected and aligned along a common axis, showing their spatial relationship and integration into the complete assembly.

In some embodiments, the ion source assembly 1000 may include an ion source core assembly 1100. FIGS. 1A-1E illustrate various aspects of the ion source core assembly 1100 in accordance with various embodiments.

As shown in FIGS. 1A and 1B, the ion source core assembly 1100 may include a first platform 1020 and a second platform 1040 arranged in a vertical configuration. In some embodiments, the first platform 1020 and the second platform 1040 may be made of 304 stainless steel. A source downstream flange 1010 may be positioned at the bottom of the ion source core assembly 1100. The ion source core assembly 1100 may include multiple bus bars 1060 with bus bar extensions 1064 that extend through platform bus bar passages 1042. A platform isolator 1030 may be positioned between components to provide electrical isolation. A lens 2410 may be mounted at the top of the assembly. The lens 2410 may be positioned on the second platform 1040.

In some embodiments, multiple thermocouples 1110 may be arranged within the ion source core assembly 1100 for temperature monitoring. Coolant lines 1120 may be integrated into the structure to provide cooling. A gas line 1130 may extend upward through the source downstream flange 1010 to deliver gas to the ionization reaction volume.

The first platform 1020 and the second platform 1040 may be coupled to one another using an inter-platform fastener 1032. In some embodiments, the platform isolator 1030 may be positioned between the first platform 1020 and the second platform 1040. The platform isolator 1030 may be made of aluminum nitride to provide electrical isolation while allowing good thermal heat transfer between the first platform 1020 and the second platform 1040. Further isolation may be provided using a sleeve washer 1034.

FIG. 1C shows a side sectional view of the ion source core assembly 1100, revealing various internal components. In this view, a feed-through 1015 is shown, which may be provided in the first platform 1020 to enable electrical connections through the source downstream flange 1010, such as by accommodating the bus bar extension 1064. A coupling 1140 may be connected to the source downstream flange 1010. Also, the first platform 1020 may include a platform inner charge rod aperture 1022, which is a central opening passing through the first platform 1020. Additionally, the first platform 1020 may include a cooling chamber 1025. The cooling chamber 1025 may have an annular form and be coupled to one or more coolant lines 1120.

As shown in FIG. 1D, the lens 2410 may include a lens aperture 2415. The lens aperture 2415 may help to focus and direct the ion beam generated within the source. The bus bars 1060 may include bus bar insulators 1065.

In some embodiments, an oven (e.g., 2000 in FIG. 4) and an anode (e.g., 2250 in FIG. 4) may be coupled to the first platform 1020. A cathode (e.g., 3000 in FIG. 4) may be coupled to the second platform 1040. The arrangement of these components on separate platforms, electrically isolated by the platform isolator 1030, may allow for the generation and control of an ion beam while maintaining appropriate electrical isolation between components.

In some embodiments, the ion source core assembly 1100 may include various internal components arranged to facilitate ion generation and control. FIG. 1E shows an exploded view of the ion source core assembly 1100, illustrating the spatial relationships between these components.

The ion source core assembly 1100 may include a source oven core assembly (e.g., 2000) positioned within the first platform 1020. In some embodiments, the source oven core assembly 2000 may include components made of high-temperature compatible materials. For example, a core inner liner 2040 and an ionization reaction volume 2085 may be made of TZM (Titanium-Zirconium-Molybdenum alloy). This material selection may allow the source oven core assembly 2000 to withstand high temperatures during operation.

In some embodiments, the core inner liner 2040 may house electrode pins 2020 and contact pins 2030. A core shield 2170 may surround these components, providing heat protection and containment. A first end cap 2070 may be positioned near the bottom of the assembly, while a second end cap 2080 may be located at the opposite end.

The ionization reaction volume 2085 may be adjacent to the source oven core assembly 2000. In some embodiments, an anode 2250 may be positioned downstream of the ionization reaction volume 2085. The anode 2250 may be made of 304 stainless steel, providing durability and conductivity for ion extraction.

In some embodiments, a cathode assembly 3000 may be located downstream of the anode 2250. The cathode assembly 3000 may be configured to generate an electron beam directed towards the ionization reaction volume 2085.

The ion source core assembly 1100 may include multiple suspension plates to support and electrically isolate various components. For example, a first suspension plate 3072 may be connected to the cathode assembly 3000, while a second suspension plate 3078 may be positioned above it. Additional suspension plates 2090 may be arranged in sequence throughout the assembly.

In some embodiments, insulators may be positioned between the suspension plates and the platforms to provide electrical isolation. For instance, an upstream insulator 3082 may be located between the first suspension plate 3072 and the first platform 1020. Similarly, a first downstream insulator 3084 and a second downstream insulator 3086 may be positioned between other suspension plates and the second platform 1040.

The lens 2410 may be positioned at the top of the ion source core assembly 1100. In some embodiments, the lens 2410 may be made of graphite. The lens 2410 may have a specific angle on its downstream side that matches the angle on an extraction lens (not shown) located downstream of the ion source core assembly 1100. This matching angle may help to focus and direct the ion beam as it exits the assembly.

In some embodiments, the arrangement of these components within the ion source core assembly 1100 may allow for efficient ion generation, extraction, and control. The use of high-temperature materials in critical components, such as platinum iridium for the core inner liner 2040 and/or TZM alloy for the ionization reaction volume 2085, may enable operation at elevated temperatures. The multiple suspension plates and insulators may provide electrical isolation between components while maintaining structural integrity.

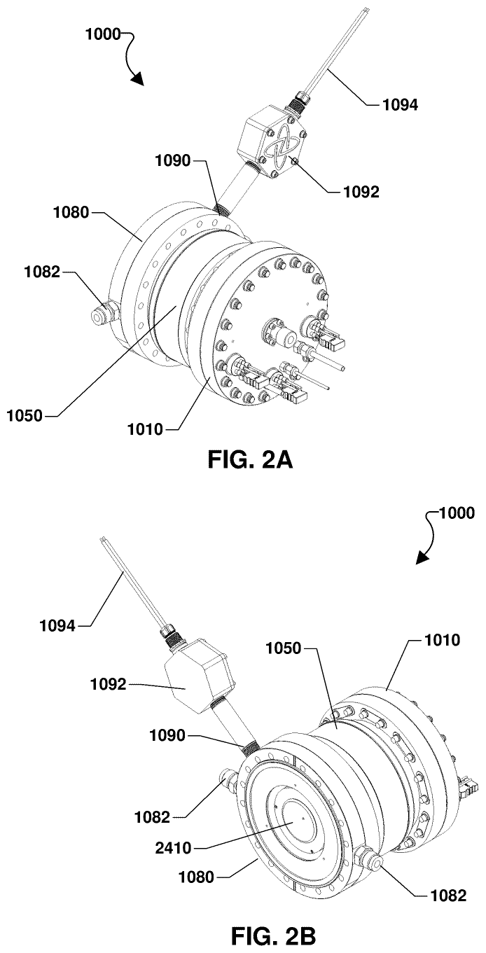

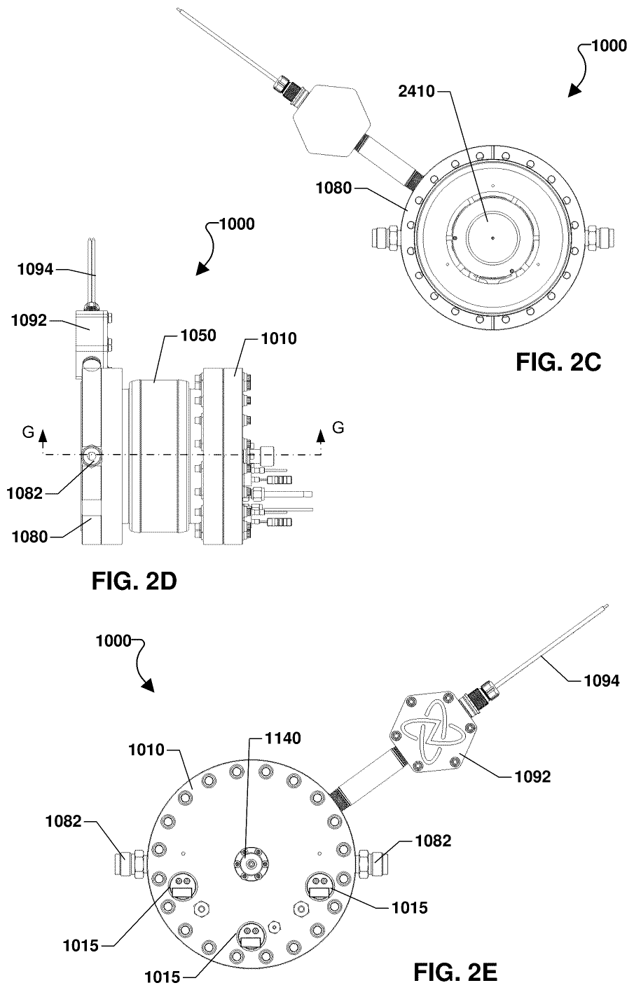

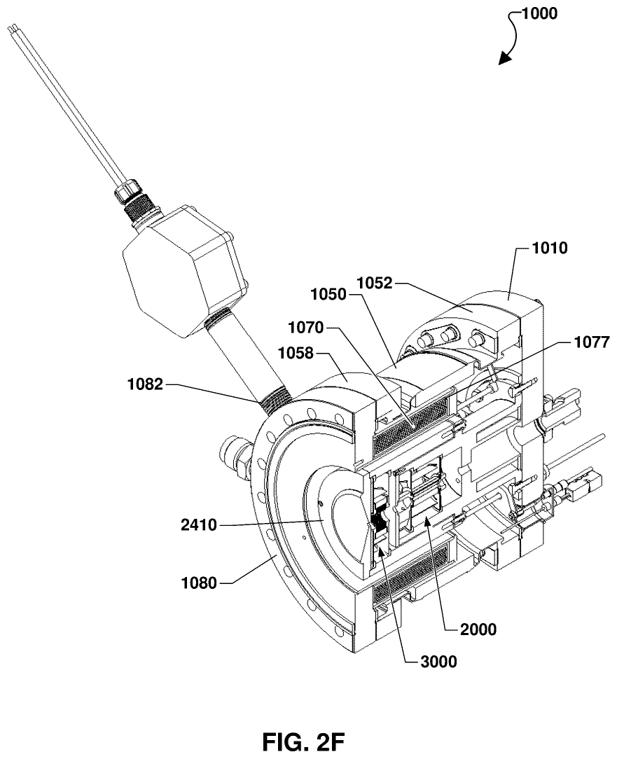

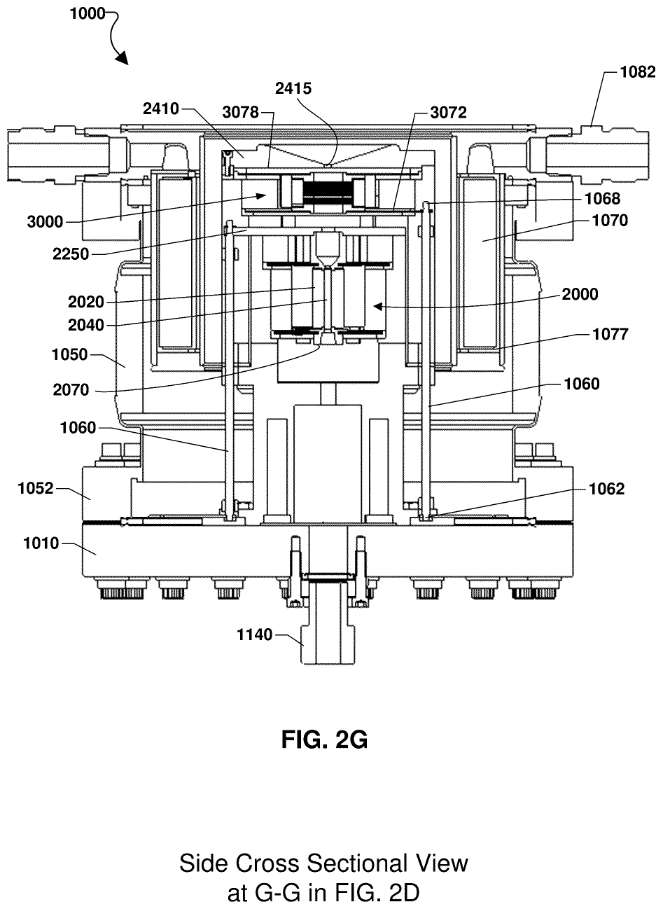

In some embodiments, an ion source assembly 1000 may include various external components that facilitate its operation and thermal management. FIGS. 2A and 2B illustrate isometric views of portions of the ion source assembly 1000, showing the arrangement of these external components.

The ion source assembly 1000 may include a source downstream flange 1010 connected to an electro-thermal isolator 1050. In some embodiments, the electro-thermal isolator 1050 may provide both electrical and thermal isolation between the ion source and the rest of the ion source assembly 1000.

A second source downstream flange 1080 may be provided with coolant ports 1082 for circulating cooling fluid to cool the source coil magnet (e.g., magnetic coil 1070 in FIGS. 2F and 2G). The coolant ports 1082 may allow for the circulation of cooling fluid through the assembly to remove heat and manage temperature during operation.

In some embodiments, the ion source assembly 1000 may include an electric feed port 1090 that connects to a junction box 1092. Supply wires 1094 may extend from the junction box 1092 to provide electrical connections to the source coil magnet. These components may facilitate the distribution of different currents, which may control a strength of the magnetic field generated by the source coil magnet.

FIGS. 2C-2E illustrate orthogonal views of the ion source assembly 1000, showing the external arrangement of components. In some embodiments, a gas line 1130 may be incorporated into the assembly. The gas line 1130 may allow for the flow of noble gases, such as xenon, into an ionization reaction volume for calibration and testing purposes.

FIG. 2F provides a sectional view of the ion source assembly 1000, revealing additional internal components. In some embodiments, a magnetic coil 1070 may surround a portion of the ion source assembly 1000. The magnetic coil 1070 may be positioned to surround at least a portion of at least one of an oven, a cathode, and an anode within the ion source assembly 1000.

The magnetic coil 1070 may include an annular cavity 1077 configured to support coolant circulation around the magnet to remove heat produced by electrical resistance in the windings. In some embodiments, the annular cavity 1077 may be part of a coil jacket 1075 surrounding the magnetic coil 1070. These structures enable the magnetic coil 1070 to be water-cooled, with cooling water flowing into the cavity via an inlet port on one side and out of the cavity via an outlet port on the other side of the annular cavity 1077.

In some embodiments, an upstream electro-thermal isolator flange 1052 may be positioned at one end of the electro-thermal isolator 1050, while a downstream electro-thermal isolator flange 1058 may be positioned at the opposite end. These flanges may help secure the electro-thermal isolator 1050 within the ion source assembly 1000.

The ion source assembly 1000 may include feedthroughs for different voltages and thermocouples. These feedthroughs may allow for the introduction of various electrical signals and temperature monitoring devices into the vacuum portion of the assembly.

In some embodiments, a first platform or a second platform within the ion source assembly 1000 may include an annular cavity holding the magnetic coil 1070. This configuration may allow for efficient cooling of the magnetic coil 1070 while maintaining its position around critical components of the ion source assembly 1000. In some embodiments, a coolant may be pumped into this annular cavity, for example via coolant lines 1120, using an external pump. After circulating in the annular cavity, the coolant may be removed via one or more additional coolant lines. The removed coolant may then be cooled and recirculated into the annular cavity. This circulation system may provide continuous cooling to the magnetic coil 1070, helping to maintain optimal operating temperatures during ion source operation. The use of an external pump and cooling system may allow for flexible control of the coolant flow rate and temperature, which may be adjusted based on the specific operating conditions of the ion source assembly.

In some embodiments, the ion source assembly 1000 may include various internal components arranged to facilitate ion generation and control. FIG. 2G illustrates a side cross-sectional view of the ion source assembly 1000, showing the arrangement of some of these internal components.

The ion source assembly 1000 may include a source oven core assembly 2000 positioned within the central region. The source oven core assembly 2000 may be configured to heat a charge material to generate neutral atoms or molecules for ionization.

A cathode assembly 3000 may be located downstream of the source oven core assembly 2000. The cathode assembly 3000 may be configured to generate an electron beam directed towards an ionization reaction volume that is positioned between the source oven and the cathode assembly. In some embodiments, an anode 2250 may be positioned between the source oven core assembly 2000 and the cathode assembly 3000.

In some embodiments, the ion source assembly 1000 may include multiple bus bars to facilitate electrical connections throughout the assembly. A bus bar 1060 may have a first end 1062 and a second end 1068. These bus bars may distribute voltages to various components within the ion source assembly 1000.

The ion source assembly 1000 may operate with specific voltage gradients applied to various components. In some embodiments, an upper body and the lens 2410 may be biased at up to approximately 10 kilovolts. The cathode assembly 3000 may be biased at approximately 9.8 kilovolts when the upper body is at 10 kilovolts. An ionization reaction volume may be biased at approximately 9.6 kilovolts, while the source oven core assembly 2000 may be biased at approximately 9.2 kilovolts when the upper body is at approximately 10 kilovolts. The resulting voltage gradients may facilitate the generation and control of the ion beam within the assembly.

In some embodiments, the ion source assembly 1000 may include thermocouples integrated into various components for temperature monitoring. Thermocouples may be incorporated into the cathode assembly 3000, the anode 2250, and the source oven core assembly 2000. These thermocouples may allow for precise temperature control and monitoring during the operation of the ion source assembly 1000.

The arrangement of these components within the ion source assembly 1000 may allow for efficient ion generation, extraction, and control. The voltage gradients applied to different components may create an electric field that guides the generated ions through the assembly and out through the lens aperture 2415.

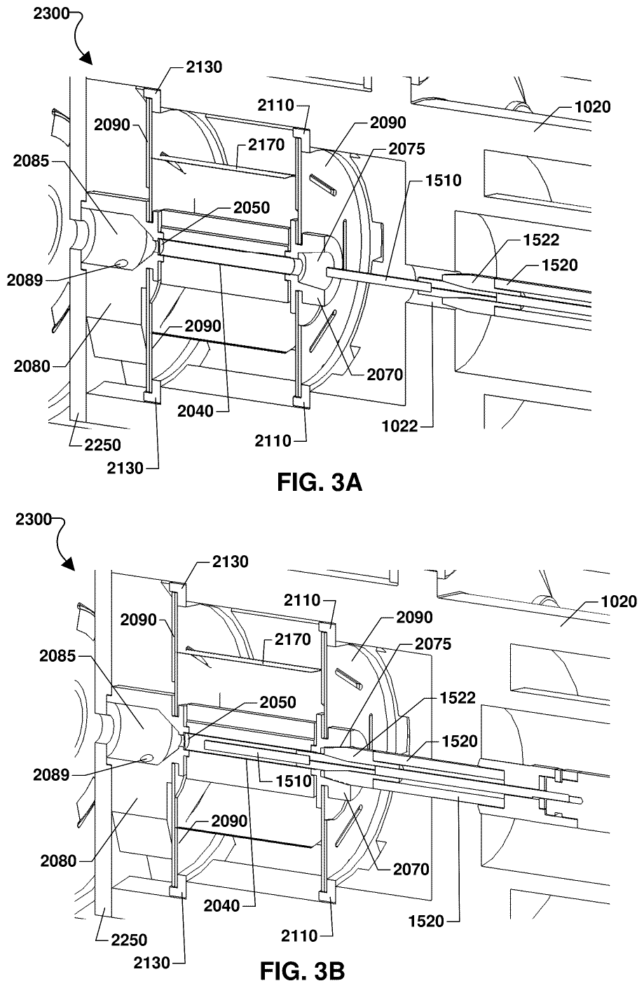

In some embodiments, the ion source assembly 1000 may include a charge rod 1510 configured to introduce charge material into the source oven of the ion source assembly 1000. FIG. 3A and FIG. 3B illustrate section views of an ionization assembly 2300 showing the arrangement of components related to the charge rod 1510 and material introduction system.

The charge rod 1510 may extend through a platform inner charge rod aperture 1022 in a first platform 1020. In some embodiments, the charge rod 1510 may be made of zirconium and/or may be a capillary rod. The charge rod 1510 may be held in position by a charge rod holder 1520 that includes a collet 1522 for securing the charge rod 1510.

In some embodiments, the charge rod holder 1520 may include a handle that can be twisted to compress an O-ring and create a vacuum seal. This configuration may allow the charge rod 1510 to be removable from the oven without disassembling the ion source assembly 1000, facilitating easier material replacement and continuous operation.

The ionization assembly 2300 may include a core inner liner 2040 positioned within the assembly. In some embodiments, the core inner liner 2040 may include an orifice disk 2050. The orifice disk 2050 may include an orifice opening that is sized to help control the flow of vaporized or sublimated source material from the charge rod 1510 into the ionization reaction volume.

A first end cap 2070 may be positioned within the ionization assembly 2300 and may include a charge rod interface 2075. The charge rod interface 2075 may provide a connection point between the charge rod 1510 and the internal components of the ionization assembly 2300.

The ionization assembly 2300 includes an ionization reaction volume 2085. The ionization reaction volume 2085 may include a lateral passage 2089 that allows for the introduction of gas for calibration, such as Xenon (Xe) or Argon (Ar).

The oven of the ion source assembly 1000 may be configured to heat the charge material introduced by the charge rod 1510 to a temperature sufficient to sublimate or vaporize the charge material. In some embodiments, the oven may be heated to a temperature between 1000° C. and 2000° C. In some embodiments, the oven may be heated to a temperature between 1200° C. and 1800° C. In other embodiments, the oven may be heated to a temperature between 1400° C. and 1600° C.

The arrangement of these components within the ionization assembly 2300 may allow for the efficient introduction and ionization of charge material within the ion source assembly 1000. The removable charge rod 1510 and the vacuum seal mechanism may enable continuous operation and easy material replacement, potentially improving the overall efficiency and usability of the ion source assembly 1000.

FIGS. 3A and 3B illustrate section views of an ionization assembly 2300 showing different operational states. The assembly includes a first platform 1020 having a platform inner charge rod aperture 1022 through which a charge rod 1510 is configured to extend. The charge rod 1510 is configured to extend through the assembly and be held by a charge rod holder 1520, which includes a collet 1522 for securing the charge rod.

The ionization assembly 2300 includes the source oven sub-assembly and the source oven core assembly. As shown, the first insulator 2110 and second insulator 2130 are positioned to provide electrical isolation between components. The core shield 2170 surrounds portions of the assembly to provide thermal shielding to protect the rest of the assembly from heat radiating from the source oven. An anode 2250 may be positioned near the second end cap 2080. The section views show how the components are arranged concentrically around the central axis defined by the charge rod 1510.

A core inner liner 2040 is positioned within the assembly and includes the orifice disk 2050. The assembly includes a first end cap 2070 with a charge rod interface 2075, and a second end cap 2080. An ionization reaction volume 2085 is defined within the assembly and includes a lateral passage 2089 for gas flow.

Multiple suspension plates 2090 may be arranged within the assembly, separated by first insulators 2110 and second insulators 2130. A core shield 2170 may surround portions of the internal components. An anode 2250 may be positioned within the assembly to establish an electrical potential that is part of the electric field that accelerates electrons into and motivates ions out of the ionization reaction volume.

The components are arranged as part of an ionization assembly 2300, which provides controlled ionization of material introduced through the charge rod 1510. The section views show how the components are concentrically arranged to maintain proper spacing and electrical isolation while allowing for gas flow and ion generation.

In the view presented in FIG. 3A, the charge rod 1510 is positioned just outside the source oven, core inner liner 2040, ready to be inserted therein. The position shown in FIG. 3A is a preloaded position. In FIG. 3B, the charge rod 1510 is shown shifted along the central axis into the fully loaded position within the core inner liner 2040. In the fully loaded position, the 1522 collet is well seated against the charge rod interface 2075, which prevents further axial movement by the charge rod 1510 toward the ionization reaction volume 2085. Supporting structure around the collet may function to form a gas seal, enabling a vacuum to be established in the source oven and the rest of the system.

In some embodiments, the ion source assembly 1000 may include a direct current (DC) ion source assembly 2400. FIG. 4 illustrates a section view of the ion source assembly 1000 showing the arrangement of components within the DC ion source assembly 2400.

The DC ion source assembly 2400 may include a lens 2410 positioned at the downstream end of the ion source assembly 1000. The lens 2410 may include a lens aperture 2415. The lens 2410 may be secured to the second platform 1040 using one or more lens fasteners 2417.

In some embodiments, the lens 2410 may be configured as an emission lens positioned downstream of a cathode assembly 3000. The lens 2410 may focus ions emitted from the ionization reaction volume 2085. A voltage applied to the lens 2410 may be adjusted to control the shape and energy of an ion beam exiting the ion source assembly 1000.

The DC ion source assembly 2400 may include an anode 2250 positioned downstream of the ionization reaction volume 2085. In some embodiments, the anode 2250 may be configured to extract generated ions from the ionization reaction volume 2085.

In some embodiments, the cathode assembly 3000 may be positioned to direct an electron beam into the ionization reaction volume 2085. The electron beam may flow in a direction opposite to the flow of ions generated through collisions with electrons in the ionization reaction volume. This configuration may allow for efficient ionization of atoms or molecules evaporated from a charge material within a source oven core assembly 2000.

The source oven core assembly 2000 may include an oven support 2072. In some embodiments, the oven support 2072 may provide structural support for components within the source oven core assembly 2000.

In some embodiments, a magnetic coil (not shown in FIG. 4) may surround at least a portion of the ion source assembly 1000. When energized, the magnetic coil may generate a magnetic field with a strength and configuration that confines or guides the electron beam as it travels from the cathode assembly 3000 into the ionization reaction volume 2085. Within the ionization reaction volume 2085—where the electron beam interacts with a mixture of the carrier gas and evaporated species—a plasma may form as ionization occurs. The magnetic field may further act to confine the resulting negatively-charged plasma prior to the extraction of positive ions through the anode 2250 and toward the lens aperture 2415.

The DC ion source assembly 2400 may incorporate multiple suspension plates to maintain electrical isolation between components. For example, a first suspension plate 3072 and a second suspension plate 3078 may be used to support and electrically isolate the cathode assembly 3000 from other components.

In some embodiments, additional suspension plates 2090 may be used to support and electrically isolate other components within the ion source assembly 1000. These suspension plates may work in conjunction with various insulators to maintain proper electrical isolation between components operating at different voltage potentials.

The arrangement of components within the DC ion source assembly 2400 may allow for efficient generation, extraction, and focusing of charge material ions produced in the ionization reaction volume. The combination of the cathode assembly 3000, ionization reaction volume 2085, anode 2250, and lens 2410 may provide a controlled path for ion generation and beam formation. The use of suspension plates and insulators may help maintain electrical isolation while allowing for the necessary voltage differentials required for ion beam control.

Implementation examples of various embodiments are described in the following paragraphs.

Example 1: An ion source assembly, including: an oven configured to receive a charge material therein through an upstream end of the oven; an ionization reaction volume adjacent a downstream end of the oven that is opposite the upstream end, wherein the ionization reaction volume is configured to receive a neutral gas therein; a cathode assembly positioned to generate an electron beam directed toward the ionization reaction volume, wherein the ionization reaction volume is disposed between the oven and the cathode assembly; and an anode positioned downstream of the ionization reaction volume, wherein the electron beam flows in a direction opposite to a flow of ions generated in the ionization reaction volume.

Example 2: The ion source assembly of example 1, further including a charge rod configured to introduce the charge material into the oven.

Example 3: The ion source assembly of any of examples 1-2, wherein the charge rod is removable from the oven without disassembling the ion source assembly.

Example 4: The ion source assembly of any of examples 1-3, further including a magnetic coil surrounding at least a portion of at least one of the oven, the cathode, and the anode.

Example 5: The ion source assembly of any of examples 1-4, wherein the oven includes a high-temperature material selected from titanium, zirconium, or molybdenum alloy.

Example 6: The ion source assembly of any of examples 1-5, further including an emission lens positioned downstream of the cathode to focus ions emitted from the ionization reaction volume.

Example 7: The ion source assembly of any of examples 1-6, further including: a first platform, wherein the oven and the anode are coupled to the first platform; a second platform secured to the first platform, where the cathode is coupled to the second platform; and a platform isolator disposed between the first and second platforms, wherein the platform isolator is configured to electrically isolate the first and second platforms from one another.

Example 8: The ion source assembly of any of examples 1-7, further including a platform isolator positioned between the first platform and the second platform to provide electrical isolation.

Example 9: The ion source assembly of any of examples 1-8, further including one or more suspension plates coupling at least one of the oven or the cathode to the respective first and second platforms.

Example 10: The ion source assembly of any of examples 1-9, further including insulators positioned between the one or more suspension plates and the respective first and second platforms to provide electrical isolation.

Example 11: The ion source assembly of any of examples 1-10, wherein at least one of the first and second platforms includes an annular cavity holding a magnetic coil, wherein the annular cavity is configured to supply coolant circulation to the magnetic coil.

Example 12: A method of generating ions, including: heating a charge material in an oven of an ion source assembly; directing an electron beam from a cathode assembly into an ionization reaction volume adjacent to the oven, wherein the electron beam flows in a direction opposite to a flow of generated ions; ionizing atoms or molecules evaporated from the charge material using the electron beam to generate ions; and extracting the generated ions through an anode positioned downstream of the ionization reaction volume.

Example 13: The method of example 12, further including focusing the extracted ions using an emission lens positioned downstream of the anode.

Example 14: The method of any of examples 12-13, wherein focusing the extracted ions includes adjusting a voltage applied to the emission lens to control a shape of an ion beam exiting the ion source assembly.

Example 15: The method of any of examples 12-14, wherein heating the charge material includes heating the oven to a temperature between 1000° C. and 2000° C.

Example 16: The method of any of examples 12-15, further including introducing the charge material into the oven using a removable charge rod.

Example 17: The method of any of examples 12-16, wherein the charge rod is removable from the oven without disassembling the ion source assembly.

Example 18: The method of any of examples 12-17, further including generating a magnetic field using a magnetic coil surrounding at least a portion of the ion source assembly.

Example 19: The method of any of examples 12-18, wherein the magnetic field is configured to confine the electron beam within the ionization reaction volume.

Example 20: The method of any of examples 12-19, further including maintaining electrical isolation between components of the ion source assembly using multiple suspension plates and insulators.

Example 21: The method of any of examples 12-20, wherein the oven includes a high-temperature material selected from titanium, zirconium, or molybdenum alloy.

Example 22: An ion source assembly, including: means for heating a charge material; means for generating an electron beam; means for ionizing atoms or molecules evaporated from the charge material using the electron beam, wherein the electron beam flows in a direction opposite to a flow of generated ions; and means for extracting the generated ions.

Example 23: The ion source assembly of example 22, wherein the means for heating a charge material includes an oven positioned within a first platform of the ion source assembly.

Example 24: The ion source assembly of any of examples 22-23, wherein the oven includes a high-temperature material selected from titanium, zirconium, or molybdenum alloy.

Example 25: The ion source assembly of any of examples 22-24, wherein the means for generating an electron beam includes a cathode assembly positioned to direct the electron beam into an ionization reaction volume adjacent to the means for heating a charge material.

Example 26: The ion source assembly of any of examples 22-25, further including means for generating a magnetic field to confine the electron beam within the ionization reaction volume.

Example 27: The ion source assembly of any of examples 22-26, wherein the means for generating a magnetic field includes a magnetic coil surrounding at least a portion of the ion source assembly.

Example 28: The ion source assembly of any of examples 22-27, wherein the magnetic coil includes means for circulating a coolant in the form of an annular cavity for coolant circulation.

Example 29: The ion source assembly of any of examples 22-28, wherein the means for extracting the generated ions includes an anode positioned downstream of an ionization reaction volume.

Example 30: The ion source assembly of any of examples 22-29, further including means for focusing the extracted ions positioned downstream of the anode.

Example 31: The ion source assembly of any of examples 22-30, wherein the means for focusing the extracted ions includes an emission lens with an adjustable voltage to control a shape of an ion beam exiting the ion source assembly.

Further embodiments include an ion source assembly that includes means for heating a charge material (e.g., oven configured to receive a charge material, source oven core assembly 2000), means for generating an electron beam (e.g., cathode assembly 3000), means for ionizing atoms or molecules evaporated from the charge material using the electron beam, wherein the electron beam flows in a direction opposite to a flow of generated ions (e.g., ionization reaction volume 2085 adjacent to the oven), and means for extracting the generated ions (e.g., anode 2250 positioned downstream of the ionization reaction volume).

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. An ion source assembly, comprising:
an oven configured to receive a charge material therein through an upstream end of the oven;
an ionization reaction volume adjacent a downstream end of the oven that is opposite the upstream end, wherein the ionization reaction volume is configured to receive a neutral gas therein;
a cathode assembly positioned to generate an electron beam directed toward the ionization reaction volume, wherein the ionization reaction volume is disposed between the oven and the cathode assembly; and
an anode positioned downstream of the ionization reaction volume, wherein the electron beam flows in a direction opposite to a flow of ions generated in the ionization reaction volume.

2. The ion source assembly of claim 1, further comprising a charge rod configured to introduce the charge material into the oven.

3. The ion source assembly of claim 2, wherein the charge rod is removable from the oven without disassembling the ion source assembly.

4. The ion source assembly of claim 1, further comprising a magnetic coil surrounding at least a portion of at least one of the oven, the cathode assembly, and the anode.

5. The ion source assembly of claim 1, wherein the oven comprises a high-temperature material including a Titanium-Zirconium-Molybdenum (TZM) alloy.

6. The ion source assembly of claim 1, further comprising an emission lens positioned downstream of the cathode assembly to focus ions emitted from the ionization reaction volume.

7. The ion source assembly of claim 1, further comprising:
a first platform, wherein the oven and the anode are coupled to the first platform; and
a second platform secured to the first platform, where the cathode assembly is coupled to the second platform.

8. The ion source assembly of claim 7, further comprising a platform isolator positioned between the first platform and the second platform to provide electrical isolation.

9. The ion source assembly of claim 7, further comprising one or more suspension plates coupling at least one of the oven or the cathode assembly to the respective first and second platforms.

10. The ion source assembly of claim 9, further comprising insulators positioned between the one or more suspension plates and the respective first and second platforms to provide electrical isolation.

11. The ion source assembly of claim 8, wherein at least one of the first and second platforms includes an annular cavity holding a magnetic coil, wherein the annular cavity is configured to supply coolant circulation to the magnetic coil.

12. A method of generating ions, comprising:
heating a charge material in an oven of an ion source assembly;
directing an electron beam from a cathode assembly into an ionization reaction volume adjacent to the oven, wherein the electron beam flows in a direction opposite to a flow of generated ions;
ionizing atoms or molecules evaporated from the charge material using the electron beam to generate ions; and
extracting the generated ions through an anode positioned downstream of the ionization reaction volume.

13. The method of claim 12, further comprising focusing the extracted ions using an emission lens positioned downstream of the anode.

14. The method of claim 13, wherein focusing the extracted ions comprises adjusting a voltage applied to the emission lens to control a shape of an ion beam exiting the ion source assembly.

15. The method of claim 12, wherein heating the charge material comprises heating the oven to a temperature between 1000° C. and 2000° C.

16. The method of claim 12, further comprising introducing the charge material into the oven using a removable charge rod.

17. The method of claim 16, further comprising removing the removable charge rod from the oven without disassembling the ion source assembly.

18. The method of claim 12, further comprising energizing a magnetic coil surrounding at least a portion of the ion source assembly to generate a magnetic field that confines the electron beam within the ionization reaction volume.

19. The method of claim 12, further comprising maintaining electrical isolation between components of the ion source assembly using multiple suspension plates and insulators.

20. An ion source assembly, comprising:
means for heating a charge material;
means for generating an electron beam;
means for ionizing atoms or molecules evaporated from the charge material using the electron beam, wherein the electron beam flows in a direction opposite to a flow of generated ions; and
means for extracting the generated ions.

21. The ion source assembly of claim 20, wherein the means for heating the charge material is positioned within a first platform of the ion source assembly.

22. The ion source assembly of claim 20, wherein the means for generating the electron beam is positioned to direct the electron beam into an ionization reaction volume adjacent to the means for heating the charge material.

23. The ion source assembly of claim 22, further comprising means for generating a magnetic field to confine the electron beam within the ionization reaction volume.

24. The ion source assembly of claim 23, wherein the means for generating the magnetic field surrounds at least a portion of the ion source assembly.

25. The ion source assembly of claim 24, wherein the means for generating the magnetic field includes means for circulating a coolant.

26. The ion source assembly of claim 20, wherein the means for extracting the generated ions comprises an anode positioned downstream of an ionization reaction volume.

27. The ion source assembly of claim 26, further comprising means for focusing the extracted ions positioned downstream of the anode.

28. The ion source assembly of claim 27, wherein the means for focusing the extracted ions comprises means for controlling a shape of an ion beam exiting the ion source assembly.
